(19) United States
(12) Patent Application Publication
(10) Pub. No.: US 2008/0075557 A1
(43) Pub. Date: Mar. 27, 2008

(54) Constant load bolt

(76) Inventors: A. David Johnson, San Leandro, CA (US); Michael Bokaie, San Leandro, CA (US); Valery Martynov, San Francisco, CA (US)

Correspondence Address: SHAY GLENN LLP, 2755 CAMPUS DRIVE, SUITE 210, SAN MATEO, CA, 94403, US

(21) Appl. No.: 11/526,138

(22) Filed: Sep. 22, 2006

(51) Int. Cl. F16B 35/00

(52) U.S. Cl. 411/392

(57) ABSTRACT

Devices and methods for making fasteners, such as bolts, having one or more components made of single crystal shape memory alloy capable of large recoverable distortions, and in particular having a plateau in the stress-strain relationship. A constant load is applied by a bolt that is tightened until the force exerted by the bolt is equal to the stress multiplied by the cross-section of a tension component in the bolt. Increasing or decreasing the length of the tension component by as much as several percent causes a negligible change in the load.

### BACKGROUND OF THE INVENTION

1. Field of the Invention

This invention relates to mechanical devices that have a component in which large recoverable distortions at constant force provide a constant load fastening.

2. Description of the Related Art

Ordinary bolts such as those made of steel and various alloys, used to secure two or more components together, are generally tightened by applying a known torque to the nut or stud. It is assumed that the holding force, or load, applied to the components of the joint is proportional to the torque. This is often not true: loads applied by this method may vary by a large factor from one installation to another.

Bolts subjected to high stress also are subject to ‘creep,’ a tendency to lose tension with time, due to a gradual relaxation of the material of which the bolts are made.

It is sometimes desirable to bind two or more objects together in such a way that the pressure exerted on the objects is limited to a known quantity.

Literature available on the World Wide Web reveals that many inventions have been made to provide solutions to the problem of providing constant load to a bolted joint.

One such prior art method is by use of suitable lubricants on the bolt threads to reduce the variation in friction as the bolt is tightened. This method may be incompatible with the purpose of the joint, for example possible contamination from the lubricants in a space mission.

Another prior art method uses a stack of Belleville washers that are engineered to provide nearly constant force as length is varied. Because Belleville washers generally have spring characteristics (force versus displacement) that are very much different from that of the bolt, the forces generated are sufficient for limited applications.

Yet another prior art method provides an array of springs to produce constant force on a clamp. A further prior art method provides an elastic washer that compresses under load.

### BRIEF DESCRIPTION OF THE DRAWINGS

FIG. 1 is an axial cross-sectional view of a component comprising a fastener in accordance with one embodiment of the invention shown in combination with structure such as flanges to which a constant load can be applied.

FIG. 2 is a side elevation view of a fastener in accordance with another embodiment.

FIG. 3 is an end view taken along the line 3-3 of the fastener of FIG. 1.

FIG. 4 is a partially cut-away perspective view of the fastener of FIG. 2.

FIG. 5 is a longitudinal section view of a fastener in accordance with a further embodiment.

FIG. 6 is a longitudinal section view of a fastener in accordance with a still further embodiment.

### OBJECTS AND SUMMARY OF THE INVENTION

The general object of this invention is to provide new and improved devices for securing together several components in such a way that the load applied to the components is constant or nearly constant. Fields of application for the invention include aerospace, military, transportation, medical appliances, and consumer products.

### DESCRIPTION OF THE PREFERRED EMBODIMENT

In its broadest concept, the present invention in the various embodiments provides devices and apparatus, such as a a bolt or other fastening device, having at least one component made of a shape memory alloy (also called SMA) which is fabricated as a single crystal.

Such single crystal SMAs are defined herein as “hyperelastic” SMA because of their properties that enable them to undergo recoverable distortions which are much larger than can be achieved in conventional materials. Thus, such distortions are greater than that which could be obtained if the component were made of non-SMA metals and alloys, and nearly an order of magnitude greater than can be obtained with polycrystalline SMA materials. The fabrication and performance of such single crystal SMA materials are disclosed in U.S. application Ser. No. 10/588,412 filed Jul. 31, 2006, the disclosure of which is incorporated by this reference.

The invention in the various embodiments places the hyperelastic component under sufficient stress so that it enters a superelastic plateau. At this stress, small variations in length produce minimal effect on the load applied by the fastening device. There is less risk that the fastening device will break under abnormal usage conditions that cause the fastening device to be significantly elongated.

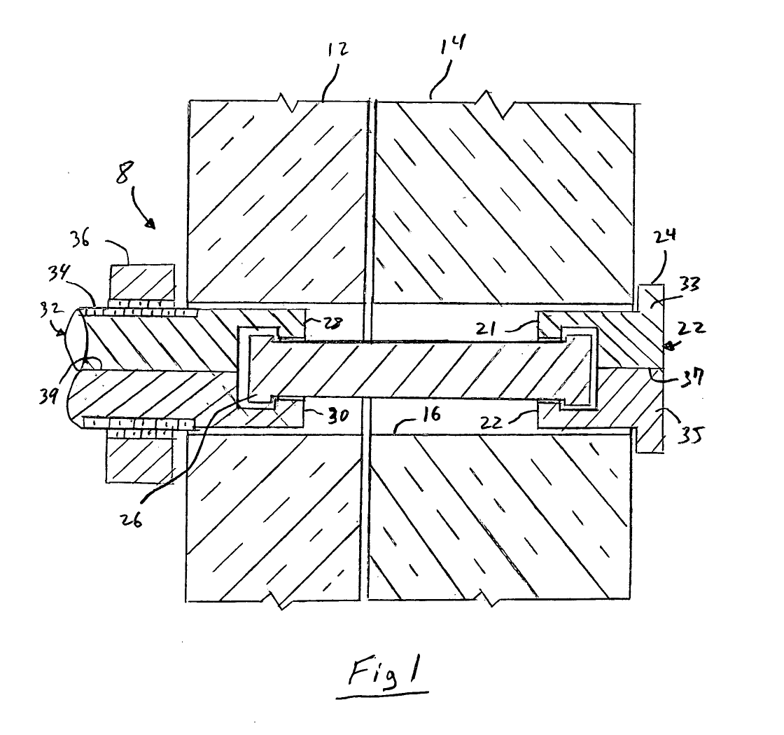

The embodiment of FIG. 1 provides a component comprising a fastener 8 which is a hyperelastic bolt 10 used to clamp and hold together under constant load separate structures, such as the illustrated pair of flanges 12 and 14. The bolt penetrates the flanges by means of a through-hole 16. One end of the bolt is formed with a circular head 18 which is captured by dog-bone shaped retaining teeth 20 and 21 that are formed in a split clamp 22. The split clamp preferably is made of steel with an enlarged boss 24 that acts as a load-bearing surface. The other end of the bolt is formed with a circular head 26 which is captured by dog-bone shaped retaining teeth 28 and 30 that are formed in a split bolt 32. The split bolt is preferably made of steel and is formed with external threads 34 onto which a nut 36 is mounted. The nut can be tightened to apply the desired holding force or load on bolt 10. As the nut is tightened, the hyperelastic SMA is stressed in linear tension.

The threaded end split bolt 32 and bossed end split clamp 22 are each fabricated in two end parts, for example part 33 and 35 which form the bossed end split clamp. The end parts are secured in retaining relationship about the hyperelastic SMA bolt by a weld 37 for the bossed end split clamp and a weld 39 along each of the two seams where the respective parts meet.

The embodiment of FIGS. 2-4 provides a elongated cylindrical fastener 40 which is comprised of a proximal end 42 and distal end 44 having respective longitudinally cylindrical bores 46 and 48. The proximal end is formed with a hex-shaped head 50 and the distal end has external threads about which a nut 52 is threaded. Head 50 and nut 52 are adapted to be fitted outside holes formed in a pair of flanges (not shown) through which the proximal and distal ends extend for holding the flanges together. The bores 46 and 48 are formed internally with respective shoulders 54 and 56 which fit against the opposite heads 58 and 60 of a hyperelastic bolt 62.

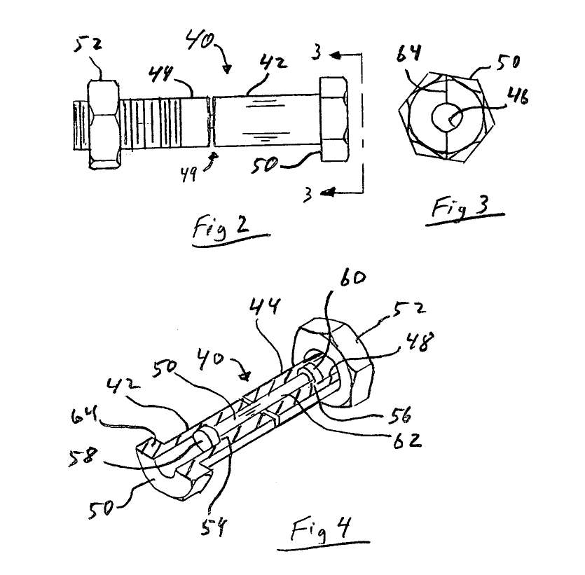

As best shown in FIG. 3 distal end 43 with head 50 are split along a radial plane which forms opposing flat surfaces 64. These surfaces are welded together to capture bolt 62 within the fastener.

High tension loads from the flanges when applied to fastener 40 are effectively resisted by hyperelastic bolt 62 which elongates within the bores 46 and 48 under constant load conditions.

The fastener proximal and distal ends are sized and proportioned so that a gap 49 is formed between their facing ends (FIG. 2) before nut 52 is tightened on the bolt. This gap provides a clearance which is sufficient to enable axial travel of the fastener ends to enable the flanges to be clamped together.

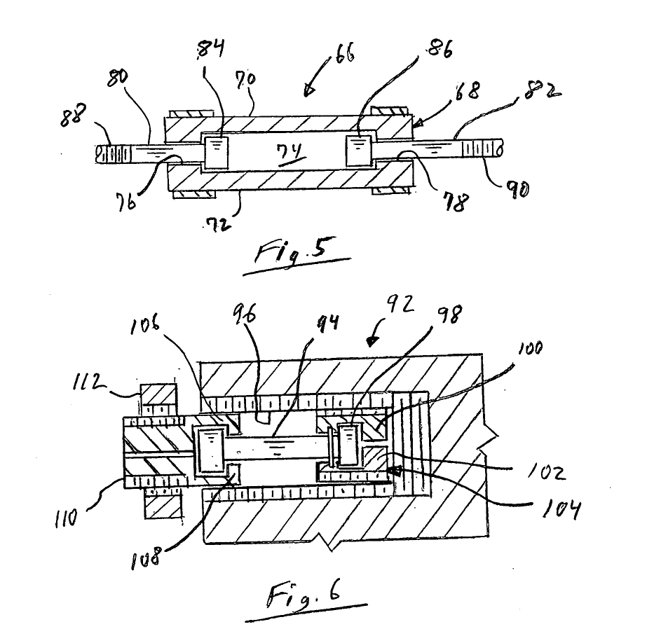

The embodiment of FIG. 5 provides a fastener 66 which comprises a cylindrical shell 68 formed of a pair of split halves 70 and 72, preferably of steel, that are joined together to form a hollow cavity 74 having openings 76 and 78 at opposite ends. The split halves of the shell are formed of single crystal hyperelastic SMA material. A pair of bolts 80 and 82 have respective enlarged head ends 84 and 86 which extend through the shell openings so that they are captured within the cavity when the split halves are joined together, as by welding. This configuration of the fastener allows the SMA shell to have a larger cross-section than the bolts to match the modulus of elasticity of the bolt material. The ends of the bolts outside the shell are threaded at 88 and 90 for attachment to any desired flange or other structure.

FIG. 6 provides a fastener structure 92 which comprises a hyperelastic bolt 94, similar in shape to bolt 10 of the embodiment of FIG. 1, for mounting within an internally threaded blind hole 96. An enlarged proximal end 98 of the bolt is captured by retaining teeth 100 and 102 of a split clamp 104. The split clamp is externally threaded for fitment with hole 96. The distal end of bolt 94 is enlarged for engagement with retaining teeth 106 and 108 which are carried by a split bolt 110. A nut 112 is threaded onto external threads on the split bolt for applying the desired load on the SMA bolt.

1. A fastener for holding at least first and second structures together, the fastener comprising a hyperelastic component having first and second ends, the first end being connected with the first structure and the second end being connected with the second structure, the hyperelastic component responding to a load applied on the fastener from the structures by distorting while maintaining the load constant.

2. A fastener as in claim 1 in which the hyperelastic component is made of single crystal CuAlNi SMA.

3. A device as in claim 1 in which the fastener comprises at least one cylinder, and at least one end of the hyperelastic component is secured to the cylinder which transfers the load to the hyperelastic component.

4. A device as in claim 3 in which at least one end of the cylinder is threaded to receive a nut for applying tension to the bolt.

5. A fastener as in claim 1 in which the hyperelastic component comprises a bolt having a shank which distorts by elongation responsive to the load.
